(19) United States
(12) Patent Application Publication
(10) Pub. No.: US 2020/0022077 A1
(43) Pub. Date: Jan. 16, 2020

(54) Energy-Saving Mobile Communication Network

(71) Applicant: P. I. Works TR Bilisim Hizm. San. ve Tic A.S., Pendik (TR)

(72) Inventors: Serkan Sofuoglu, San Ramon, CA (US); Ömer Narmanlioglu, Atasehir (TR); Yakup Tarik Kranda, Atasehir (TR)

(21) Appl. No.: 16/033,564

(22) Filed: Jul. 12, 2018

(51) Int. Cl. H04W 52/02; H04W 36/08; H04W 36/16

(52) U.S. Cl. CPC H04W 52/0206; H04W 52/0261; H04W 36/16; H04W 36/08

(57) ABSTRACT

The energy-savings state of a cellular network access area is determined at the cluster level where each cluster includes multi-carrier sectors having high handover attempts to one another. To determine if the cluster can transition into an energy-savings state, key performance indicators for the cluster are evaluated. Each sector-level KPIs is converted into a cluster-level KPI by taking the maximum value of the sector-level KPI across the cluster. The cluster-level KPIs can indicate that the cluster can transition into the energy-savings state when the cluster's user count and/or its capacity utilization are lower than first predetermined threshold values. The order that each frequency layer in the cluster transitions into and out of an energy-savings state is determined by the frequency layer's energy-savings priority.

### TECHNICAL FIELD

This disclosure generally relates to the field of mobile communication systems. More specifically, it relates to centralized energy saving mechanisms in multi-carrier cellular communication systems that minimize service quality degradation of subscribers while minimizing energy consumption in mobile communication systems.

### BACKGROUND

Mobile communication systems (MCSs) are typically dimensioned to provide carrier-grade quality of service (QoS). Radio network resources are installed and configured to maintain a specific QoS for expected maximum resource request attempts from subscribers. This results in a number of various overlay radio access technologies (RATs) (e.g., Universal Mobile Telecommunications System (UMTS) Terrestrial Radio Access Network (together, UTRAN), Evolved UTRAN (E-UTRAN), New Radio (NR) and also a multitude of overlay frequencies within each RAT). Eventually, due to designs based on peak traffic, carried traffic peak-to-average ratio increases, reducing overall efficiency of the system in terms of system utilization and power consumption to keep the system operational. Turning off underutilized cell carriers in an overlay network (e.g., during early morning hours; on holidays in business districts) aims at increasing efficiency especially in terms of network cell level power consumption. The 3rd Generation Partnership Project (3GPP) energy savings related specifications (e.g., 3GPP Technical Specification (TS) 36.300 clause 22.4.4.2) define the need for energy savings and explain mechanisms to turn off and re-activate carriers.

Existing energy-savings methods describe various mechanisms to enter and leave energy-savings states for a base station in a vertical manner taking each base station as a separate entity due to the 3GPP standard's focus on distributed autonomous mechanisms. FIG. 1 is a schematic representation of an uncoordinated, autonomous energy savings decision by an overlay network 10 comprising base stations (BSs) BS 1 and BS 2. Each base station BS 1, BS 2 has two frequency layers 1A, 1B and 2A, 2B, respectively. However, BS 1 and BS 2 have entered an energy-savings state where they have turned off frequency layer 1B and 2A, respectively (as indicated by the dashed line). As a result, the network 10 is required to perform an inter-frequency (IF) handover 16 for user 10's device, from frequency layer 2B to frequency layer 1A, as user 10 moves toward BS 1. In addition, the network 10 is required to perform an IF handover 14 for user 12's device, from frequency layer 1A to frequency layer 2B, as user 12 moves toward BS 2.

A holistic approach which looks at the number of selected base stations in a horizontal manner is missing. For example, cellular areas covering shopping districts, main roads, and train/metro lines in city centers carry high-mobility traffic which may be served by numerous vertically- and horizontally-deployed cellular carriers. In such areas, uncoordinated, autonomous energy savings decisions by each base station may result in patchy, discontinuous service coverage for each RAT carrier deployed in the region. In this situation, users that are highly mobile may need to perform many inter-frequency handovers in active mode or inter-frequency cell re-selections in idle mode. These extra handovers may cause increased call drop, reduced throughput during transition to other frequency while extra user equipment (UE) battery life consumption during mobile user equipment (UE) frequency search operations.

Therefore, a practical enhanced energy saving solution without introducing degradation on service quality of subscribers is needed.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

An aspect of the invention is directed to a computer-implemented method for coordinating energy savings in a cellular network access area comprising base stations, each base station having at least one multi-carrier sector, the method comprising: identifying first and second multi-carrier sectors having a highest handover attempt in the cellular network access area; forming a cluster comprising the first and second sectors; determining if the cluster is a candidate for energy savings; and when the cluster is a candidate for energy savings, generating an energy-savings command that causes a power level reduction and a locking of at least one carrier in each sector within the cluster.

In one or more embodiments, determining if the cluster is a candidate for energy savings comprises determining if an action condition has been satisfied. In one or more embodiments, determining if the action condition has been satisfied comprises: determining a current capacity utilization of each sector of the cluster; determining a maximum of the current capacity utilization across all sectors of the cluster to provide a cluster capacity utilization; comparing the cluster capacity utilization to a pre-defined threshold value; and determining that the action condition is satisfied when the cluster capacity utilization is lower than the pre-defined threshold value. In one or more embodiments, determining if the action condition has been satisfied comprises: determining a current user count of each sector of the cluster; determining a maximum of the current user count across all sectors of the cluster to provide a cluster user count; comparing the cluster user count to a pre-defined threshold value; and determining that the action condition is satisfied when the cluster user count is lower than the pre-defined threshold value.

In one or more embodiments, the method further comprises after the power level reduction and the locking of the at least one carrier in each sector within the cluster, determining whether an emergency condition for the cluster has been satisfied; and when the emergency condition for the cluster has been satisfied, unlocking the at least one carrier in each sector within the cluster regardless of an energy-savings priority for the at least one carrier in each sector within the cluster; and generating a power level change command that causes a power level increase of the at least one carrier in each sector within the cluster to a first power level. In one or more embodiments, the method further comprises (a) waiting for a predetermined time period; (b) after step (a), generating a second power level change command that causes a second power level increase of the at least one carrier in each sector within the cluster to a second power level, the second power level being a stepwise increase from the prior power level; (c) repeating steps (a) and (b) until the second power level equals an operational power level for the at least one carrier in each sector within the cluster.

In one or more embodiments, the method further comprises after the power level reduction and the locking of the at least one carrier in each sector within the cluster, determining whether a rollback condition for the cluster has been satisfied; and when the rollback condition for the cluster has been satisfied, unlocking the at least one carrier in each sector within the cluster; and generating a power level change command that causes a power level increase of the at least one carrier in each sector within the cluster to a first power level. In one or more embodiments, the method further comprises (a) waiting for a predetermined time period; (b) after step (a), generating a second power level change command that causes a second power level increase of the at least one carrier in each sector within the cluster to a second power level, the second power level being a stepwise increase from the prior power level; (c) repeating steps (a) and (b) until the second power level equals an operational power level for the at least one carrier in each sector within the cluster.

In one or more embodiments, generating the energy-savings command comprises generating a first power level change command that causes a power level decrease of the at least one carrier in each sector within the cluster to a first reduced power level. In one or more embodiments, the method further comprises (a) waiting for a predetermined time period; (b) after step (a), generating a second power level change command that causes a second power level decrease of the at least one carrier in each sector within the cluster to a second reduced power level, the second reduced power level being a stepwise decrease from the prior reduced power level; (c) repeating steps (a) and (b) until the second reduced power level of the at least one carrier in each sector within the cluster reaches a lower limit; and (d) after step (c), locking the at least one carrier in each sector within the cluster.

In an aspect, an emergency condition may comprise turning ON all carriers/objects that were OFF, for example, at the same time, and for example independent of priority. In another aspect, a rollback condition comprises turning ON one carrier/frequency per iteration once a respective condition is satisfied.

In yet another aspect, low priority carriers/frequencies may be turned OFF first, while high priority carriers/frequencies may be turned ON first.

Another aspect of the invention is directed to a computer-implemented method for coordinating energy savings in a cellular network access area comprising base stations, each base station having at least one multi-carrier sector, the method comprising: identifying first and second multi-carrier sectors having a highest handover attempt in the cellular network access area; forming a cluster comprising the first and second sectors; determining if the cluster is a candidate for energy savings; and when the cluster is a candidate for energy savings: determining an energy-savings priority for each frequency layer in the cluster; identifying the frequency layer having the lowest energy-savings priority in the cluster; and generating an energy-savings command that causes a power level reduction and a locking of the lowest energy-savings priority frequency layer in each sector within the cluster.

In one or more embodiments, the energy-savings priority for each frequency layer is determined based at least in part on (a) whether a corresponding sector that comprises the frequency layer operates in different frequency bands, (b) a site deployment density proximal to the base station having the corresponding sector; (c) a bandwidth of the frequency layer, or (d) a combination of any of the foregoing. In one or more embodiments, the method further comprises identifying a third multi-carrier sector having a highest handover attempt to the first or second multi-carrier sector; and adding the third multi-carrier sector to the cluster. In one or more embodiments, the method further comprises maintaining a minimum number of active carriers in each sector while the cluster is in an energy-saving state.

In one or more embodiments, the method further comprises after the power level reduction and the locking of the lowest energy-savings priority frequency layer in each sector within the cluster to form an energy-saving frequency layer in each sector within the cluster, determining whether an emergency condition for the cluster has been satisfied; and when the emergency condition for the cluster has been satisfied, unlocking each energy-saving frequency layer in each sector within the cluster regardless of their energy-savings priority; and generating a power level change command that causes a power level increase of each energy-saving frequency layer in each sector within the cluster to a first power level. In one or more embodiments, the method further comprises (a) waiting for a predetermined time period; (b) after step (a), generating a second power level change command that causes a second power level increase of each energy-saving frequency layer in each sector within the cluster to a second power level, the second power level being a stepwise increase from the prior power level; and (c) repeating steps (a) and (b) until the second power level equals an operational power level for each energy-saving frequency layer in each sector within the cluster.

In one or more embodiments, the method further comprises after the power level reduction and the locking of the lowest energy-savings priority frequency layer in each sector within the cluster, determining whether a rollback condition for the cluster has been satisfied; and when the rollback condition for the cluster has been satisfied, unlocking the highest energy-savings priority frequency layer in each sector within the cluster; and generating a power level change command that causes a power level increase of the highest energy-savings priority frequency layer in each sector within the cluster. In one or more embodiments, the method further comprises (a) waiting for a predetermined time period; (b) after step (a), generating a second power level change command that causes a second power level increase of the highest energy-savings priority frequency layer in each sector within the cluster, the second power level being a stepwise increase from the prior power level; (c) repeating steps (a) and (b) until the second power level equals an operational power level for the highest energy-savings priority frequency layer in each sector within the cluster.

In one or more embodiments, generating the energy-savings command comprises generating a first power level change command that causes a power level decrease of the lowest energy-savings priority frequency layer in each sector within the cluster to a first reduced power level. In one or more embodiments, the method further comprises (a) waiting for a predetermined time period; (b) after step (a), generating a second power level change command that causes a second power level decrease of the lowest energy-savings priority frequency layer in each sector within the cluster to a second reduced power level, the second reduced power level being a stepwise decrease from the prior reduced power level; (c) repeating steps (a) and (b) until the second power level of the lowest energy-savings priority frequency layer in each sector within the cluster to a second power level reaches a lower limit; and (d) after step (c), locking the lowest energy-savings priority frequency layer in each sector within the cluster.

### BRIEF DESCRIPTION OF THE DRAWINGS

For a fuller understanding of the nature and advantages of the present concepts, reference is made to the following detailed description of preferred embodiments and in connection with the accompanying drawings, in which:

FIG. 1 is a schematic representation of an uncoordinated, autonomous energy savings decision by an overlay network according to the prior art;

FIG. 2 schematically illustrates a centralized energy saving self-organizing network (SON) system according to one or more embodiments;

FIG. 3 is a flow chart of a method for coordinating energy savings in a cellular network access area according to one or more embodiments;

FIG. 4 is a flow chart of the data collection step from FIG. 3;

FIG. 5 illustrates an example of an ES priority table according to one or more embodiments;

FIGS. 6 and 7 are a flow chart for the clustering step from FIG. 3;

FIG. 8 illustrates an example of sector-based aggregation;

FIGS. 9, 10, 11, and 12 are a flow chart for the turn on/off determination step from FIG. 3;

FIGS. 13, 14, and 15 are a flow chart of the command generation step from FIG. 3; and

FIG. 16 illustrates an architecture for carrying out one or more embodiments of the present invention.

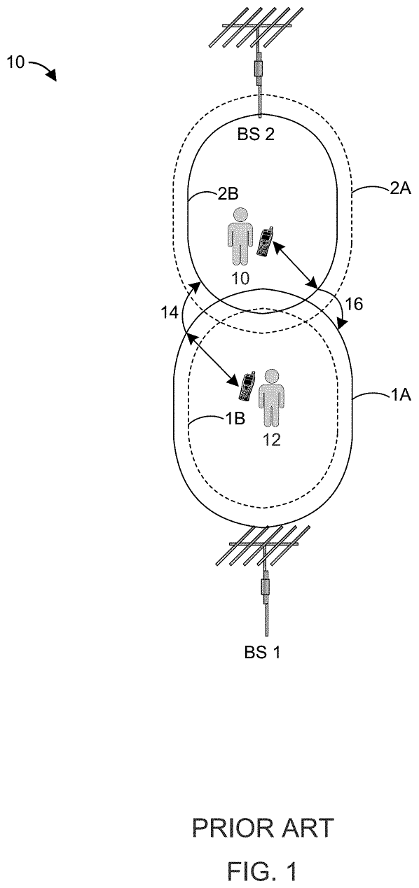

### DETAILED DESCRIPTION

The energy-savings state of a cellular network access area is determined at the cluster level where each cluster includes sectors having high handover attempts to one another. To determine if the cluster can transition into an energy-savings state, key performance indicators (KPIs) for the cluster are evaluated. Each sector-level KPIs is converted into a cluster-level KPI by taking the maximum value of the sector-level KPI across the cluster. The cluster-level KPIs can indicate that the cluster can transition into the energy-savings state when the cluster's user count and/or its capacity utilization are lower than first predetermined threshold values.

The order that each frequency layer in the cluster transitions into an energy-savings state is determined by the frequency layer's energy-savings priority. The energy-savings priority is based on (a) whether a corresponding sector that comprises the frequency layer operates in different frequency bands, (b) a site deployment density proximal to the base station having the corresponding sector; (c) a bandwidth of the frequency layer, or (d) a combination of any of the foregoing. When entering into an energy-savings state, the frequency layer with the lowest energy-savings priority is selected first.

To determine if the cluster needs to transition out of an energy-savings state, the cluster-level KPIs are evaluated to determine if they are greater than second or third predetermined values. The second predetermined values can correspond to a rollback condition where the cluster's user count and/or its capacity utilization have modestly increased but network performance and/or QoS have not degraded. The third predetermined values can correspond to an emergency condition where the cluster's user count and/or its capacity utilization have significantly increased such that network performance and/or QoS have degraded. When exiting an energy-saving state, the frequency layer with the highest energy-savings priority is selected first.

Since aspects of the invention make use of existing standard procedures to get ES-related data (e.g., KPIs) and send commands to the network (e.g., for operations, administration, and maintenance or OAM) from a centralized server (e.g., SON server via OSS), they can be implemented without significant cost or expense.

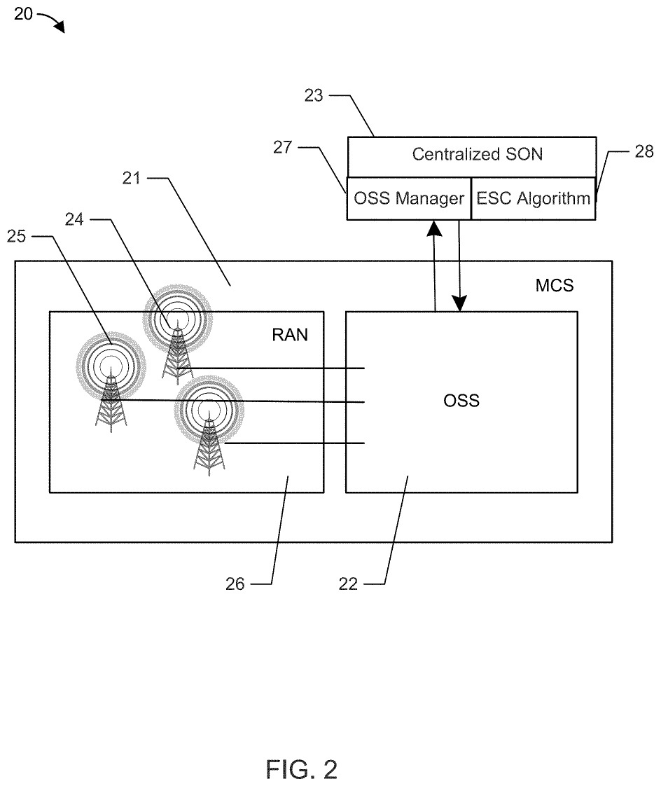

FIG. 2 schematically illustrates a centralized energy saving self-organizing network (SON) 20 according to one or more embodiments. The ES system 20 includes a centralized self-organizing network (SON) processor 23, which autonomously and dynamically executes programmed operations and instructions according to the design of the ES system 20 in certain embodiments disclosed herein. The operational support system (OSS) 22 contains data regarding the performance and configuration of the mobile communication system (MCS) 21. Base station node 24 generates cellular signals 25 that permit communication between mobile units (e.g., cellular mobile telephone subscriber devices) and the wider telephony network. These nodes are sometimes called “NodeB” for Third Generation MCS (e.g., Universal Mobile Telecommunications System (UMTS)) or “eNodeB” for Fourth Generation MCS (e.g., Long Term Evolution (LTE)). The base station nodes 24 and their controller nodes (e.g. RNC for UMTS—not shown in FIG. 2 for simplicity) collectively define a radio access network (RAN) 26. A communications link, such as an X2 link (e.g., in 4G LTE), can be formed between neighboring base station nodes 24.

The SON processor 23 includes an OSS Manager 27 that communicates instructions, commands, and data to/from the OSS. The OSS Manager 27 is in communication with an energy-saving control (ESC) algorithm 28 that analyzes the RAN 26 to determine whether any portion of it can enter into an energy-saving (ES) state and to determine whether any portion of the RAN 26 needs to exit the ES state. Additional details of the ESC algorithm 28 are described below.

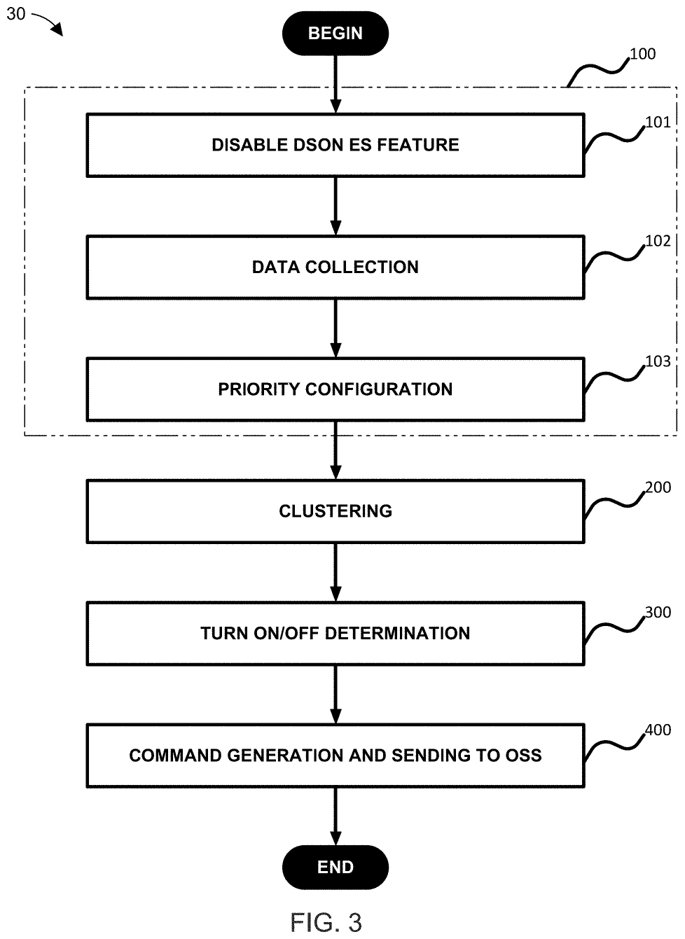

FIG. 3 is a flow chart 30 of a method for coordinating energy savings in a cellular network access area according to one or more embodiments. The flow chart 30 includes pre-processing 100, clustering sectors 200, determining which sectors to turn on or off 300, and generating commands 400.

Pre-processing 100 includes disabling the distributed SON (dSON) ES feature 101 (if already configured in the network), collecting data 102, and configuring ES priority 103. In step 101, the dSON ES parameter(s)/feature is/are disabled in MCS regions which may include multivendor deployments (e.g., neighboring base stations are from different vendors). The dSON ES state, as defined by 3GPP, permits the ES states for each base station to be controlled in an autonomous manner where each base station is viewed as a separate entity. Instead, when the ES configuration decision is made by centralized SON (cSON) (e.g., ES 20), then, base station ES states can be controlled centrally (e.g., by SON processor 23 via OSS 22).

In step 102, data on the cellular network access area is collected

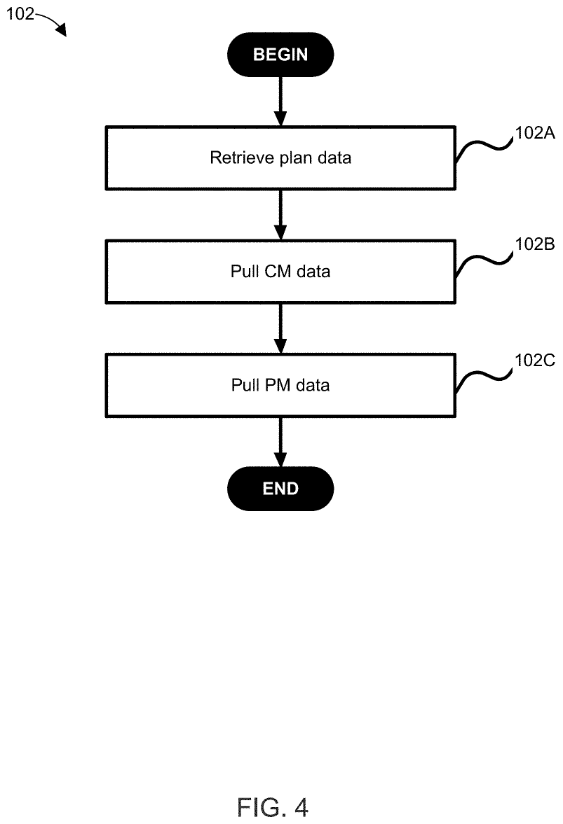

by the SON processor 23. The collected data includes plan data 102A, configuration management (CM) data 102B, and performance management (PM) data 102C, as illustrated in FIG. 4.

The plan data collected in step 102A can include the identity (e.g., site name, site id, cell name, cell id, radio access technology (RAT), broadcasted physical cell identity, antenna azimuth) and physical location (e.g., coordinates) of each base station and their configured cells/antennas. The CM data collected in step 102B can include the cell-based configuration parameters (e.g., (E)-UARFCN, frequency bandwidth, and power-related parameters.) The CM data can be pulled from a CM interface or CM file(s) from OSS.

The PM data collected in step 102C can include cell and relation-based OSS counters regarding LTE and UMTS cells that are collected during one or more observation periods (e.g., N×15 minutes, N=1, 2, 3, etc. for the target cellular network access area). Examples of the PM data collected include the number of active users, the number of call setup failures, the percentage of radio resource utilization, the number of handover attempts, etc. on the cell level and on the cell relation level (where applicable). The PM data can be produced in OSS and collected by the SON processor 23 with a minimum data reporting period (ROP) such as 15 min or 60 min (or other N×15 minutes) depending on operator configuration. The counters can include eNodeB and NodeB PM counters. The eNodeB PM counters can correspond to the PM data of one or more E-UTRAN cells of one or more eNodeBs. The NodeB PM counters can correspond to the PM data of one or more UTRAN cells of one or more NodeBs. The SON ES server can obtain the eNodeB PM counters from an LTE OSS. The SON ES server can obtain the NodeB PM counters from a UMTS OSS.

In step 103, the SON processor 23 configures or determines the ES priority of each carrier (e.g., frequency) for each base station category and carrier ID. The ES priority can be based on network parameters (e.g., data collected in step 102)) and/or based on operator-configured parameters. The ES priority represents the order in which each carrier/frequency/channel at each base station in the cellular network access area will be turned off when entering an ES state (and turned on when exiting an ES state), as further described herein.

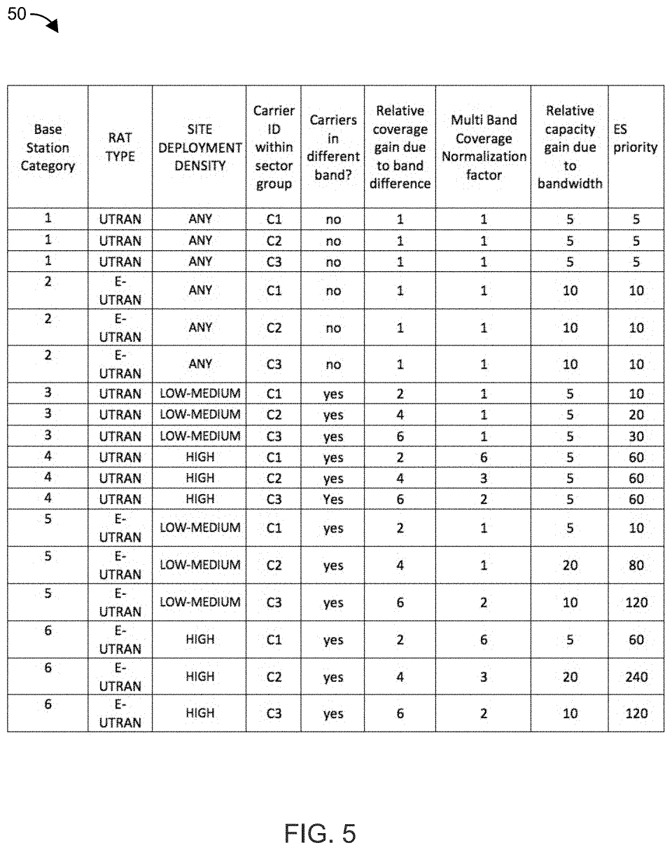

FIG. 5 illustrates an example of an ES priority table 50 according to one or more embodiments. ES priority table 50 includes, for each Base Station Category (Base Station Cat), the RAT Type (such as 3G/UTRAN or LTE/E-UTRAN), carrier identifier (Carrier ID), the deployment density of the neighboring base stations (Site Deployment Density), an indication whether the other carriers that broadcast from the same base station are in different bands (e.g., carrier C1 at the base station operates in the sub 1 Ghz 3G/UTRAN frequency band and carrier C2 at the same base station operates in a higher-frequency band), the relative coverage gain due to the frequency band difference, a multi-band coverage normalization factor, the relative capacity gain due to bandwidth, and the ES priority. A base station that includes 3G and LTE RATs can be viewed as having a combination of a base station category for each RAT (e.g., base station categories 1 and 2, or base station categories 3 and 5). The ESC algorithm 28 runs for each combination of base station categories in parallel within each RAT.

The “relative coverage gain due to the frequency band difference” value reflects the fact that a lower frequency-band signal propagates farther, and thus has better coverage, than a higher frequency-band signal. This is relevant when determining which channel or frequency band to power down in ES mode. For example, powering down a lower-frequency signal would eliminate more coverage area from a base station than powering down a higher-frequency signal from the base station. When all the carriers operate in the same frequency band, there is no material coverage gain due to the frequency band difference and this value is set to 1, as in base station categories 1 and 2 in ES table 50. When the carriers operate in different frequencies, the value of the relative coverage gain due to the frequency band difference can have a higher value for low-frequency RATs and a lower value for high-frequency RATs.

The multi-band coverage normalization factor can be based, at least in part, on (a) the site deployment density or (b) drive test scanner measurement results. For example, where the site deployment density is high (e.g., in an urban environment or near a transportation hub such as a train station), the distance between the base stations is relatively low. This also means the coverage area of each base station is relatively low, for example due to a reduction in power, antenna tilting (electrical and/or mechanical), and/or antenna relocations. Therefore, when entering an ES state, it is less important to maintain the wider coverage area that is available with low-frequencies. For example, base station category 4 in ES table 50 is in a region with a high site deployment density. Carrier C1 has a relatively high frequency and thus a low relative coverage gain due to band difference (value of 2) compared to carriers C2 and C3, but this can be compensated for or normalized by using a high multi-band coverage normalization factor (value of 6) compared to carriers C2 and C3.

Drive test scanner measurement results, where available, provide the percentage of served carriers in the region, which enable configuring multi band coverage normalization factor terms per carrier accordingly.

The relative capacity gain due to bandwidth represents the bandwidth (e.g., in MHz) of each channel/carrier. An increase in bandwidth corresponds to an increase in the maximum number of users that the channel/carrier can support and/or to an increase in the average user throughput (speed).

The ES priority is determined as the product of (a) the relative coverage gain due to band difference, (b) the multi-band coverage normalization factor, and (c) the relative capacity gain due to bandwidth. For example, the ES priority of C1 at base station 1 is 1×1×5=5.

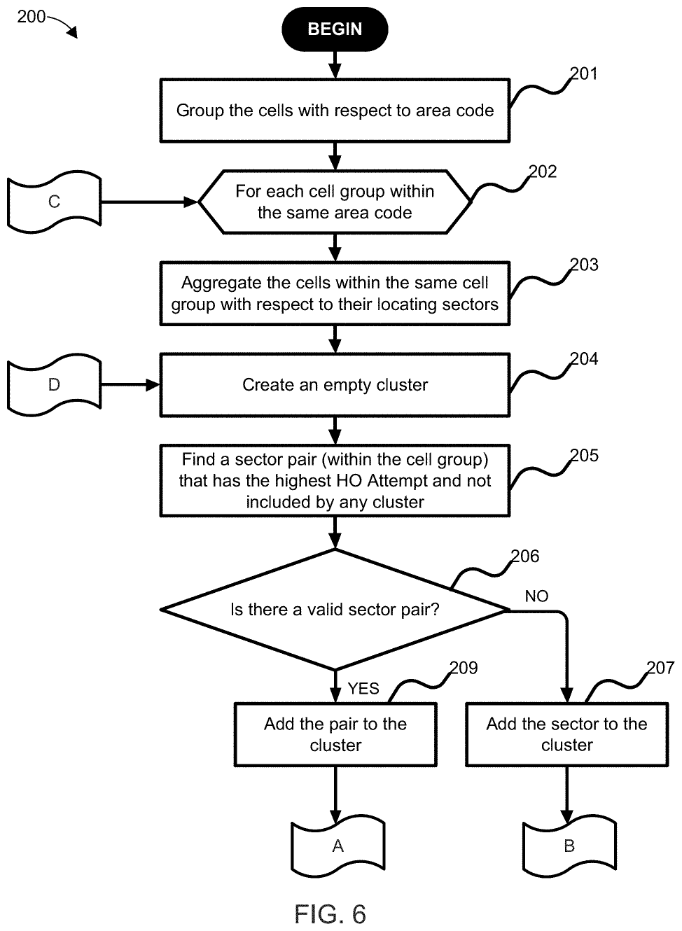

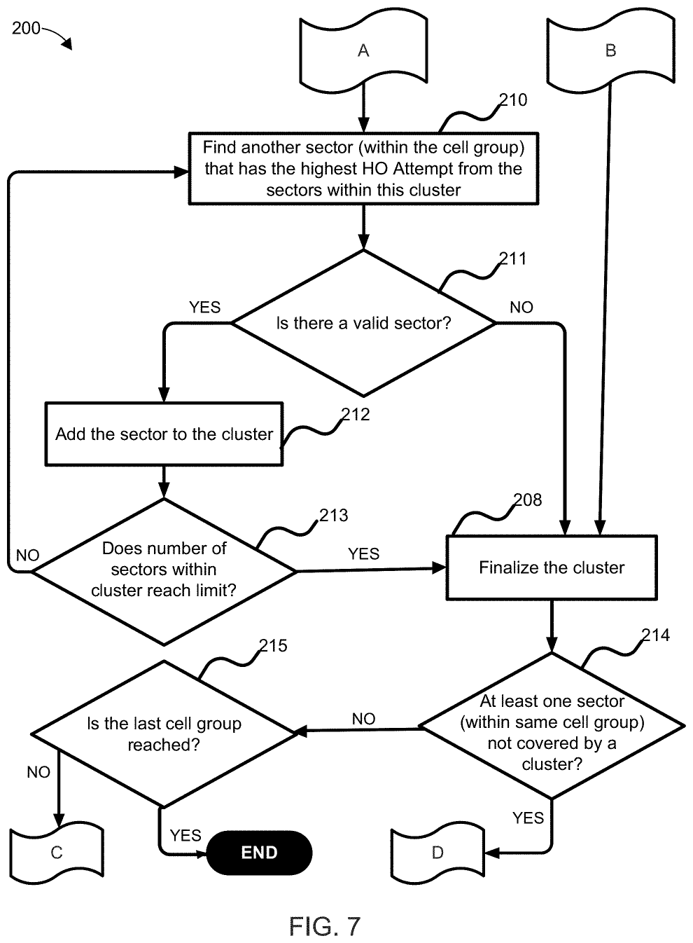

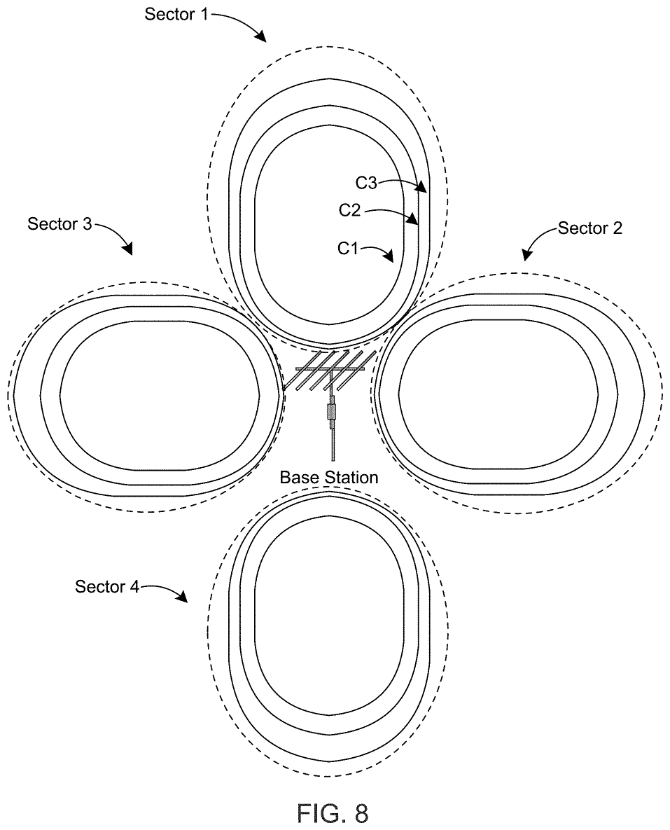

After the ES priority is configured in step 103, the flow chart proceeds to clustering sectors 200, which is illustrated in more detail in FIGS. 6 and 7. In step 201, the cells are grouped according to their location, routing, or tracking area code. An ES determination is made for only one group of cells at a time in the same area code (step 202). This prevents an ES determination for cells that cross locations, routings, or tracking area codes. In step 203, the cells within each cell group are aggregated or sub-grouped base on their locating sectors. For example, cells within the cell group that have antennas facing the same or a similar angular direction (i.e., azimuth), such as within about 10 degrees of one another, are aggregated or sub-grouped. An example of sector-based aggregation is illustrated in FIG. 8 which illustrates an overlay network having sectors 1-4 from a base station, each sector including cells C1-C3.

In step 204, an empty “cluster” is created, which is a grouping of one or more sectors. In step 205, the pair of sectors with the highest number of handover attempts within the cell group is determined by SON processor 23. That is, the number of handover attempts from any cell in a first sector to any cell in a second sector is determined (e.g., based on the data collected in step 102). In step 206, the SON processor 23 confirms if a valid sector pair was found in step 205. Examples of when a valid sector pair cannot be found include (a) when there is only one sector that uses the specific location, routing, or tracking area code, (b) there are no handover attempts between the sectors (or remaining sectors) within the same cell group (that is generated based on the same location, routing, or tracking area code usage), or (c) a sector pair cannot be found.

If there is a valid sector pair, that pair is added to the cluster in step 209, and the flow chart proceeds to placeholder A, which continues in FIG. 7. If there is no valid sector pair, the individual sector is added to the cluster in step 207, and the flow chart proceeds to placeholder B, which continues in FIG. 7.

In FIG. 7, the flow chart proceeds to step 210 from placeholder A. In step 210, the SON processor 23 searches for other sectors that have incoming and outgoing handover attempts to any sector in the cluster and determines which sector has the highest number of such handover attempts. In step 211, the SON processor 23 determines whether a sector was identified in step 210. If the SON processor 23 did not identify a sector that had any handover attempts to a sector in the cluster, the cluster is finalized in step 208. Otherwise, the sector having the highest number of handover attempts is added to the cluster in step 212. In step 213, the SON processor 23 determines whether the number of sectors in the cluster has reached a maximum value or limit. If the limit has been reached, the cluster is finalized in step 208. If the number of sectors in the cluster is below the limit, the flow chart returns to step 210 to find another sector with the highest number of handover attempts to/from one of the sectors in the cluster. This loop continues until the cluster limit is reached at which point the cluster is finalized, as discussed above.

After the cluster is finalized in step 208, which also occurs following placeholder B, the SON processor 23 determines whether there is at least one remaining sector in the cell group that has not been assigned to a cluster. If yes, the flow chart proceeds to placeholder D, which continues at step 204 in FIG. 6 where a new empty cluster is created. The above process is repeated for the new cluster and any other clusters until all sectors in the cell group that have assigned to a cluster, at which point the flow chart proceeds to step 215. In step 215, the SON processor 23 determines whether all cell groups have been clustered. If additional cell groups need to be clustered, the flow chart proceeds to placeholder C, which continues at step 202 in FIG. 6 where the clustering process is repeated for the next cell group. This process continues until all cell groups have been clustered, at which point the flow chart for clustering 200 ends.

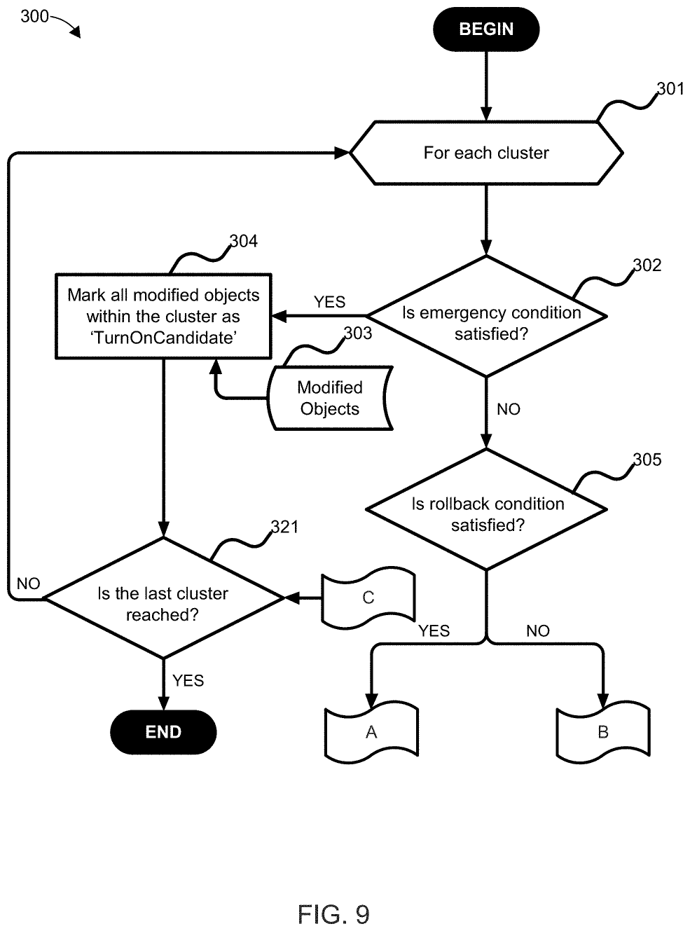

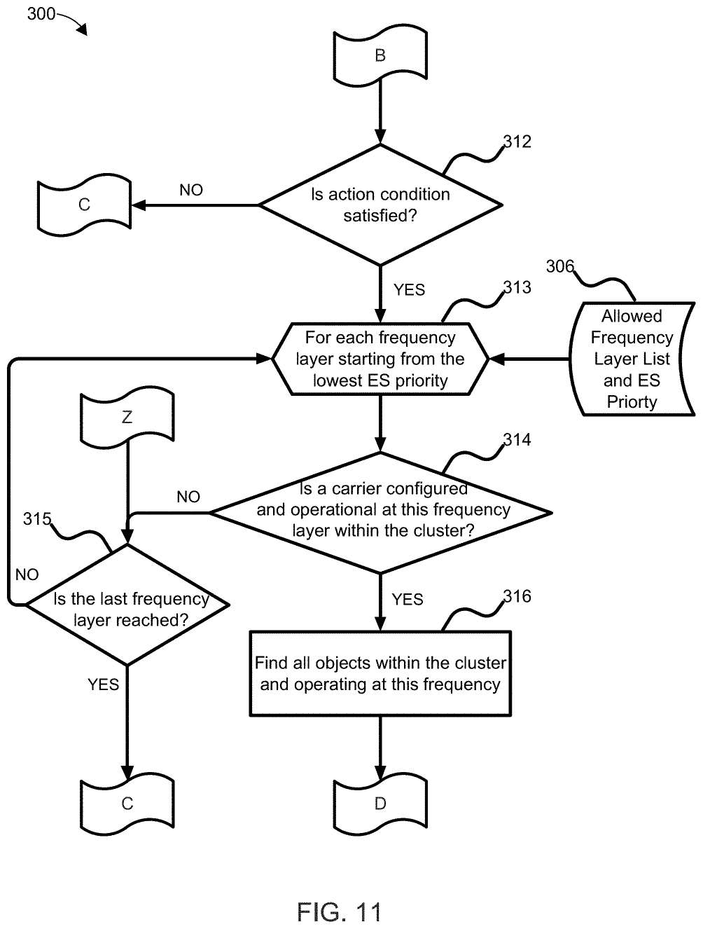

After clustering 200 ends, flow chart 30 continues to step 300 to determine which sectors to turn on or off 300. Step 300 is illustrated in more detail in FIGS. 9-12. In step 301, the SON processor 23 selects a cluster to evaluate whether to turn one or more of its carriers on or off (e.g., to exit or enter the ES state). For the selected cluster, the SON processor 23 determines whether there is an emergency condition (step 302) or a rollback condition (step 305), which indicate that one or more sectors in the cluster may need to be taken out of the ES state. If neither of these conditions is satisfied (e.g., none of the sectors is in an ES state or the cluster's user count is low), the flow chart proceeds to placeholder B, which continues at step 312 in FIG. 11.

In step 312, the SON processor 23 determines whether an action condition for the cluster has been satisfied. The action condition can include one or more pre-defined rules based on KPIs for the cluster. For example, the pre-defined rules can be based on whether a given KPI is higher or lower than an upper or lower limit, respectively, for the KPI.

Since the cell-based KPIs for a cluster may include 3G KPIs and LTE KPIs, it is desirable to convert these KPIs into cluster-based KPIs. Examples of cell-based KPIs for 3G include Capacity Failures (CAPACITY_FAILS) and High-Speed Downlink Packet Access User Count (HSDPA_USER_COUNT). Examples of cell-based KPIs for LTE include Physical Resource Block Utilization (PRB_UTIL) and Radio Resource Control Connected User Equipment Count (RRC_CON_UE_COUNT), which generally correspond to the above 3G KPIs. In general, the conversion rule is to get the maximum value of the KPIs of the cells within the same cluster. The conversion for these KPIs is as follows:

HSDPA_USER_COUNT(cluster)=Max(HSDPA_USER_COUNT[cells within the same cluster]) (1)

CAPACITY_FAILS(cluster)=Max(CAPACITY_FAILS[cells within the same cluster]) (2)

PRB_UTIL(cluster)=Max(PRB_UTIL[cells within the same cluster]) (3)

RRC_CON_UE_COUNT(cluster)=Max(RRC_CON_UE_COUNT[cells within the same cluster]) (4)

The action condition(s) for 3G can be the following:

CAPACITY_FAILS(cluster)<TH_1 AND HSDPA_USER_COUNT(cluster)<TH_2 (5)

The action condition(s) for LTE can be the following:

PRB_UTIL(cluster)<TH_3AND RRC_CON_UE_COUNT(cluster)<TH_4 (6)

In equations (5) and (6), TH_1-TH_4 are pre-defined numerical thresholds that can be set automatically or by an operator.

If the action condition is satisfied in step 312, the flow chart proceeds to step 313, where each frequency or channel in the cluster starting from the lowest ES priority is evaluated. An input to step 312 is the allowed frequency layer list and the ES priority list. These lists can be in the form of a two-dimensional array and includes the UARFCNs and E-UARFCNs (in general ((E-)UARFCNs) and their ES priority as the output of flexible ES priority selection (step 103). The order is based on ES priority with respect to each other. The first carrier/frequency layer is selected first in step 313 from the lowest ES priority. Carrier turn-off and turn-on order is determined by carrier ES priorities with respect to each other. The lower the priority, the earlier the carrier will be selected for turn-off operation. Similarly, the higher the priority, the earlier it will be selected for turn on operation. If carriers have same ES priority setting as output of flexible ES priority selection, operator pre-set order is used. If ES priority is same and operator input does not exist. then (E-)UARFCNs are prioritized in ascending order.

For the carrier/frequency layer selected in step 313, the SON processor 23 determines if a carrier is configured and operational at this frequency layer within the cluster in step 314. For example, the SON processor 23 determines whether at least one active carrier that is in the cluster and operate at the (E-)UARFCN value under consideration. If not, the flow chart proceeds to step 315 to determine if the last frequency layer or (E-)UARFCN value has been processed through step 314. If at least one additional frequency layer or (E-)UARFCN value needs to be processed through step 314, the flow chart returns to step 313 to select another frequency layer or (E-) UARFCN value. However, if all frequency layers or (E-)UARFCN values have been processed through step 314, the flow chart proceeds to placeholder C, which continues at step 321 in FIG. 9.

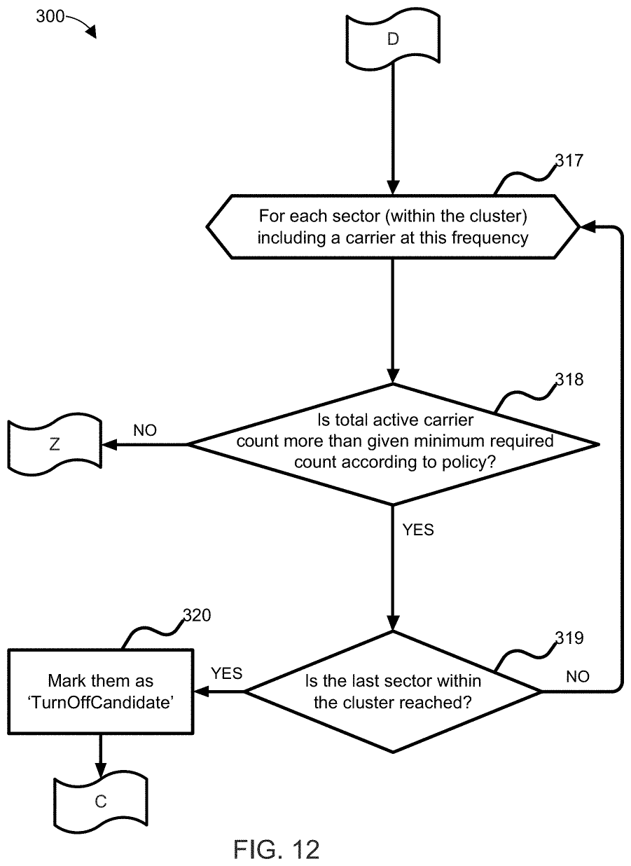

If the SON processor 23 determines that the carrier is configured and operational at this frequency layer within the cluster in step 314, the flow chart proceeds to step 316 to find all active carrier that are in the cluster that operate at the (E-)UARFCN value under consideration are found. Next, the flow chart proceeds to placeholder D, which continues at step 317 in FIG. 12.

In step 317, each sector within the cluster that includes a carrier operating at the given frequency or (E-)UARFCN value is evaluated separately. In step 318, the SON processor 23 determines if the total active carrier count is more than a minimum required count according to a policy, which may be set by the operator. This step keeps at least a specified or a minimum number of carriers active per sector to provide a minimum amount of coverage. In step 319, if there are other sectors in the clusters that include a carrier at this frequency that need to be evaluated at step 318, the flow chart returns to step 317. Otherwise, the flow chart proceeds to mark the sector(s) where the total active carrier count is more than a minimum required count as a “TurnOffCandidate” to enter the ES state in step 320. After step 320, the flow chart proceeds to placeholder C, which continues at step 321 in FIG. 9.

In step 321, the SON processor 23 determines if all cluster have been processed through steps 302-320. If additional clusters need to be processed, the flow chart returns to step 301. If not, the flow chart for step 300 ends.

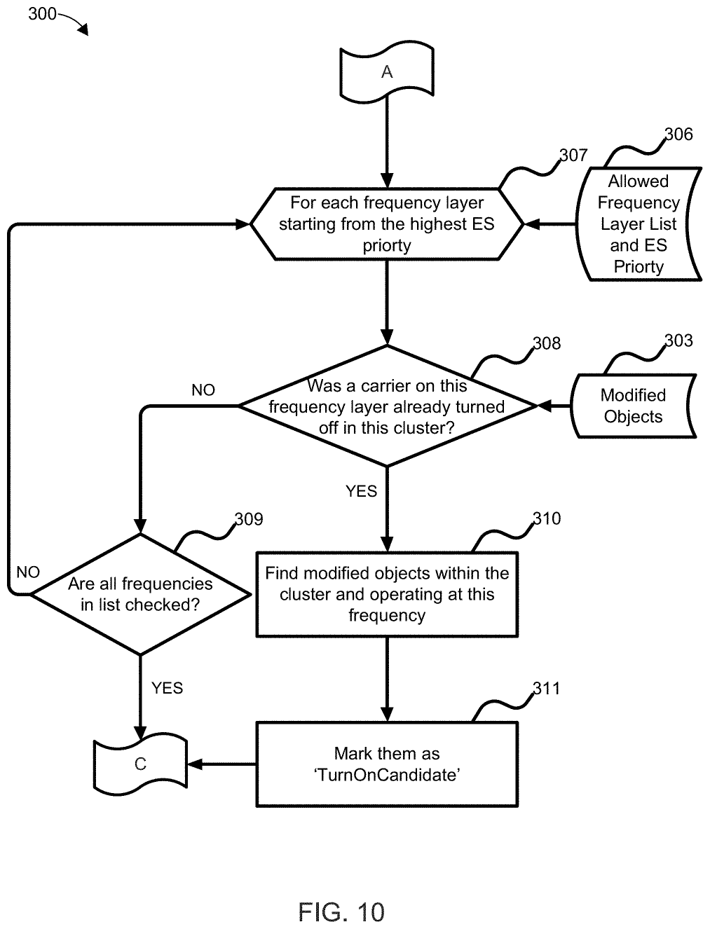

If the SON processor 23 determines that the total active carrier count is not more than the minimum required count according to a policy in step 318, the flow chart proceeds to placeholder Z, which continues at step 315 in FIG. 10, as discussed above.

Returning to FIG. 9, if an emergency condition is satisfied in step 302, the flow chart proceeds to step 304 to mark all modified objects 303 within the cluster as a “TurnOnCandidate” to exit the ES state in step 304. The modified objects 303 are objects whose CM parameters have been changed by the energy saving control module requested from the OSS 22. Examples of CM parameters include cell lock, cell un-lock, cell power settings decrease/increase (common pilot channel power, reference signal power, transmitted total sector-carrier power, etc.). After step 304, the flow chart proceeds to step 321 to determine if the last cluster has been reached, as discussed above.

An emergency condition in step 302 can be based on a pre-defined rule set based on KPI threshold values. First, the cell-based KPIs for 3G and LTE are converted to sector-based KPIs as discussed above.

The emergency condition(s) for 3G can be the following:

CAPACITY_FAILS(cluster)>TH_EM1OR HSDPA_USER_COUNT(cluster)>TH_EM2 (7)

The emergency condition(s) for LTE can be the following:

PRB_UTIL(cluster)>TH_EM3OR RRC_CON_UE_COUNT(cluster)>TH_EM4 (8)

In equations (7) and (8), TH_EM1-TH_EM4 are pre-defined numerical thresholds for emergency conditions that can be set automatically or by an operator.

If a rollback condition is satisfied in step 305, the flow chart proceeds to placeholder A, which continues at step 307 in FIG. 10. A rollback condition can be based on a pre-defined rule set based on KPI threshold values. First, the cell-based KPIs for 3G and LTE are converted to sector-based KPIs as discussed above.

The rollback condition(s) for 3G can be the following:

CAPACITY_FAILS(cluster)>TH_RB1OR HSDPA_USER_COUNT(cluster)>TH_RB2 (7)

The rollback condition(s) for LTE can be the following:

PRB_UTIL(cluster)>TH_RB3OR RRC_CON_UE_COUNT(cluster)>TH_RB4 (8)

In equations (7) and (8), TH_RB1-TH_RB4 are pre-defined numerical thresholds for rollback conditions that can be set automatically or by an operator. In general, the rollback conditions thresholds TH_RB1-TH_RB4 are lower than the respective emergency condition thresholds TH_EM1-TH_EM4. In other words, rollback is implemented first before the KPI values deteriorate to the level of an emergency condition when the quality of service may be degraded.

If a rollback condition is satisfied, the flowchart proceeds to step 307, as discussed above. In step 307, a loop is created through steps 308-311 for each frequency layer starting from the highest ES priority. This is the opposite order of step 313 because the frequency layers are turned back on in the reverse order in which they are turned off (i.e., last off, first on). In step 308, the SON processor 23 determines whether a carrier on this frequency layer has already been turned off in this cluster. For example, the SON processor 23 determines whether there is at least one modified object 303 that is in the cluster and operates at the (E-)UARFCN value under consideration. If so, the SON processor 23 finds all modified objects within the cluster that are operating at this frequency or (E-)UARFCN value in step 310 and marks them as a TurnOnCandidate in step 311. If the SON processor 23 determines that carrier on this frequency layer has not been turned off in this cluster in step 308, the flow chart proceeds to step 309 to determine if all frequency layers or (E-)UARFCN values have been processed through step 308. If not all frequency layers or (E-)UARFCN values have been processed through step 308, the flow chart returns to step 307 to check the frequency layer having the next highest ES priority. However, if all frequency layers or (E-)UARFCN values have been processed through step 308, the flow chart proceeds to placeholder C, which continues at step 321 in FIG. 9, as discussed above.

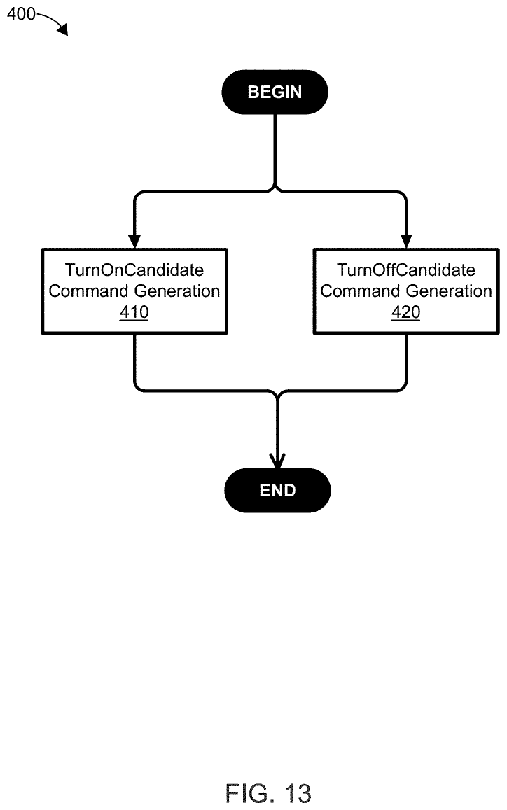

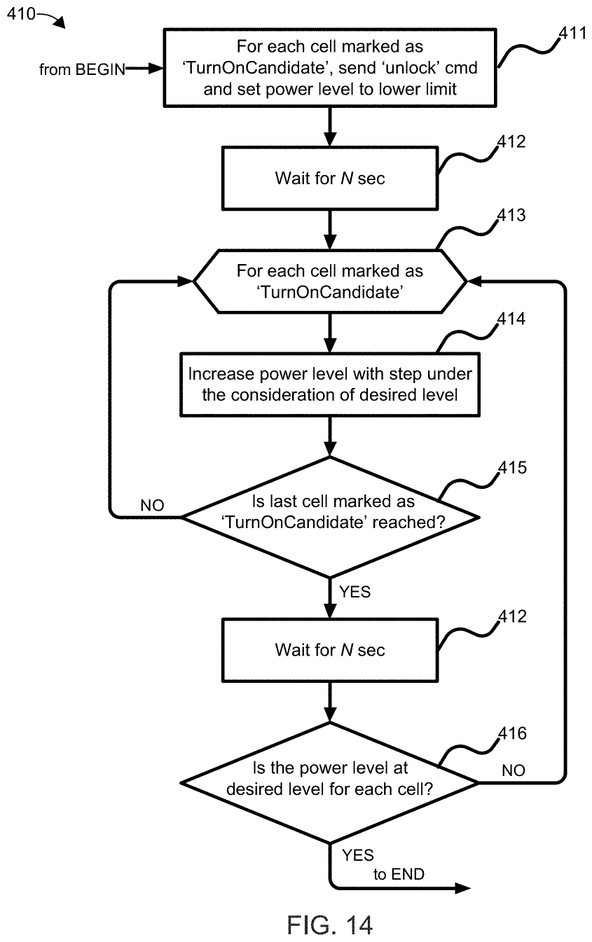

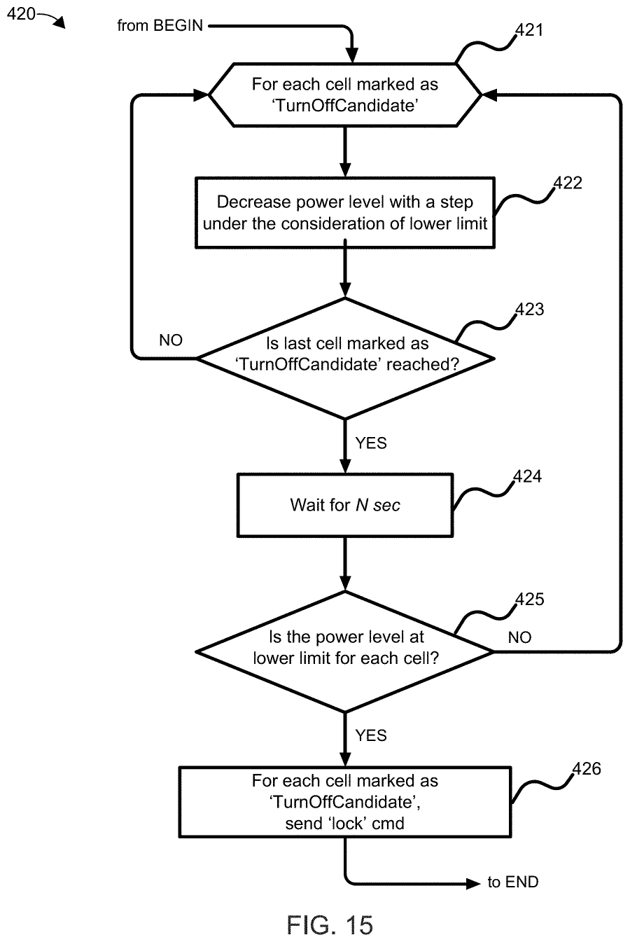

After step 300 is completed, flow chart 30 proceeds to step 400 where commands are generated and sent to OSS. Additional details of step 400 are included in FIGS. 13-15. In FIG. 13, the step 400 is separated into command generation for TurnOnCandidates 410 (illustrated in more detail in FIG. 14) and command generation for TurnOffCandidates 420 (illustrated in more detail in FIG. 15).

The flow chart for command generation for TurnOnCandidates 410 begins at step 411 where an “unlock” command is sent to each cell marked as a TurnOnCandidate and a power change command is generated for the cells to set their power level to an available lower limit. In step 412, the process waits for N seconds before proceeding to step 413. In step 413, one of the cells marked as a TurnOnCandidate is selected to proceed through steps 414 and 415. This process repeats for each cell marked as a TurnOnCandidate. In step 414, power change commands are generated in order to increase the power level stepwise. The power change commands set the power level to the MINIMUM of “CurrentValue+StepSize” and “DesiredLevel.” In step 415, the SON processor 23 determines if the last cell marked as a TurnOnCandidate has been processed through step 414. If not, the flow chart returns to step 413 to select another cell marked as a TurnOnCandidate to process through step 414.

After all cells marked as a TurnOnCandidate have been processed through step 414, the flow chart proceeds to step 412 to wait for N seconds before proceeding to step 416. In step 416, the SON processor 23 determines if the power level at each cell is set at the desired power level, which can be the operational power level for the respective cell. If not, the flow chart returns to step 413 where each cell marked as a TurnOnCandidate is processed through step 414 to stepwise increase the power level a second time. This loop continues until the SON processor 23 determines that the power level at each cell is set at the desired power level in 416 at which point the flow chart for generating commands for TurnOnCandidates 410 ends.

The flow chart for command generation for TurnOffCandidates 420 begins at step 421 where one of the cells marked as a TurnOffCandidate is selected to proceed through step 422. This process repeats for each cell marked as a TurnOffCandidate. In step 422, the SON processor 23 generates power change commands in order to stepwise decrease the power level for each cell to its lower limit. The power change commands set the power level to the MAXIMUM of “CurrentValue-StepSize” and “LowerLimit.”

In step 423, the SON processor 23 determines if the last cell marked as a TurnOffCandidate has been processed through step 422. If not, the flow chart returns to step 421 to select another cell marked as a TurnOffCandidate to process through step 422.

After all cells have been processed through step 422, the flow chart proceeds to step 424 to wait for N seconds before proceeding to step 425. In step 425, the SON processor 23 determines if the power level at each cell is set at the lower limit. If not, the flow chart returns to step 421 where each cell marked as a TurnOffCandidate is processed through step 422 to stepwise decrease the power level a second time. This loop continues until the SON processor 23 determines that the power level at each cell is set at the lower limit in 425 at which point the flow chart proceeds to step 426. In step 426, the SON processor 23 generates and sends a lock command to each cell marked as a TurnOffCandidate. After step 426, the flow chart for generating commands for TurnOffCandidates 420 ends.

One technical advantage of embodiments of the invention is that IF handover execution success rate, connection robustness, and/or user throughput are improved because less inter-frequency measurements/IF handover events will be performed. For inter-frequency cell reselection and handover, UE has to perform measurements either in compressed mode (3G) or measurement gap (LTE) which causes increased UE battery consumption, increased call drops, and decreased uplink and downlink throughput (e.g., because the UE could have used those measurement slots for data transmission otherwise).

Another technical advantage of embodiments of the invention is for operators where a mix of carrier frequency operating bands and channel bandwidth are used. Embodiments of the invention provide a centralized entity to determine which carrier(s) take(s) the role of base coverage for that particular cluster or region depending on various constraints described herein.

Another technical advantage of embodiments of the invention is that centralized ES management does not require signaling overhead between base stations while they are in a distributed ES management state.

Another technical advantage of embodiments of the invention is that they do not rely on an X2 interface (in case of LTE) whose operation may be suboptimal due to practical field issues such as X2 misconfiguration, X2 not operational due to transport faults between base stations, inter-vendor interoperability issues, inappropriately-added X2 relations by commonly-deployed SON automated neighbor relation (ANR) function. A centralized ES SON does not rely on the performance of the X2 interface capabilities (e.g. between different equipment vendors). Instead, the ES SON runs the ES algorithm at the OAM level and manages ES states via OAM connectivity with the base stations through the OSS Manager.

Another technical advantage of embodiments of the invention is that in distributed implementations where UE uplink signals/measurements are used to trigger when to exit an energy saving state, resuming/deactivation of the ES state may suffer from the fact that one UE measurement can trigger the resuming/deactivation process. In a centralized case, as disclosed herein, base station level and/or cluster level aggregated statistical data enables more than one UE request to be taken into account during cell resuming/deactivation for ES purposes. Therefore, resuming/deactivation of the ES state does not occur prematurely.

Though the invention has been described with respect to 3G and 4G/LTE RATs, it is contemplated that the invention can be applied to next-generation RATs such as 5G and beyond. The application to future technologies can include using a closed-loop optimization processor to reduce overall energy consumption in an MCS and at the same time maintaining or minimizing the degradation on MCS operating parameters such as network dropped call rate, inter-frequency call transfer rate, and/or user throughput levels due to energy consumption minimization actions.

The invention should not be considered limited to the particular embodiments described above, but rather should be understood to cover all aspects of the invention as fairly set out in the attached claims. Various modifications, equivalent processes, as well as numerous structures to which the invention may be applicable, will be apparent to those skilled in the art to which the invention is directed upon review of this disclosure. The claims are intended to cover such modifications and equivalents.

The above-described embodiments may be implemented in numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above.

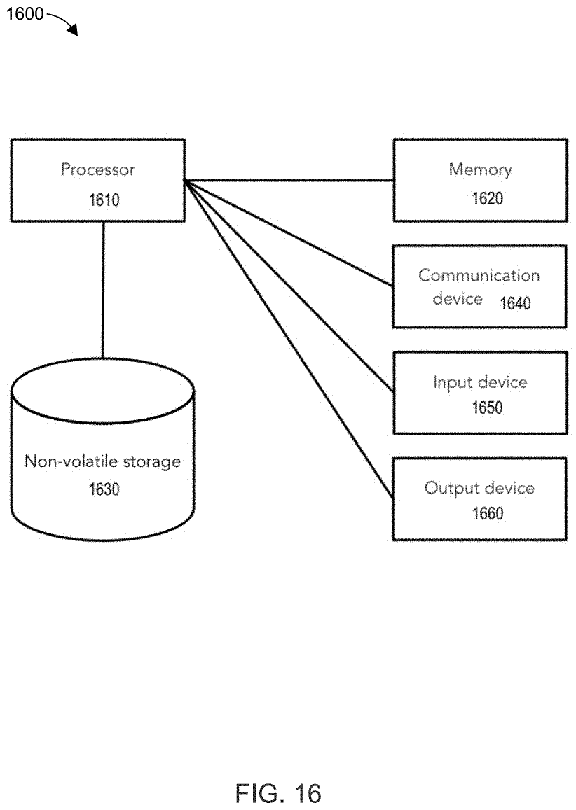

Referring to FIG. 16, in accordance with at least some embodiments, the architecture 1600 may include one or more processors 1610 and one or more articles of manufacture that comprise non-transitory computer-readable storage media (e.g., memory 1620 and one or more non-volatile storage media 1630). The processor 1610 may control writing data to and reading data from the memory 1620 and the non-volatile storage device 1630 in any suitable manner, as the aspects of the disclosure provided herein are not limited in this respect. The storage media may store one or more programs and/or other information for operation of the architecture 1600. In at least some embodiments, the one or more programs include one or more instructions to be executed by the processor 1610 to provide one or more portions of one or more tasks and/or one or more portions of one or more methods disclosed herein. In some embodiments, other information includes data for one or more portions of one or more tasks and/or one or more portions of one or more methods disclosed herein. To perform any of the functionality described herein, the processor 1610 may execute one or more processor-executable instructions stored in one or more non-transitory computer-readable storage media (e.g., the memory 1620), which may serve as non-transitory computer-readable storage media storing processor-executable instructions for execution by the processor 1610.

When implemented in software, the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more communication devices 1640, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices 1650 and/or one or more output devices 1660. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of the present application need not reside on a single computer or processor, but may be distributed in a modular fashion among a number of different computers or processors to implement various aspects of the present application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the present disclosure and claims include new and novel improvements to existing methods and technologies, which were not previously known nor implemented to achieve the useful results described above. Users of the present method and system will reap tangible benefits from the functions now made possible on account of the specific modifications described herein causing the effects in the system and its outputs to its users. It is expected that significantly improved operations can be achieved upon implementation of the claimed invention, using the technical components recited herein. Again, the existing uncoordinated methods for putting carriers into and out of an energy-savings state are undesirable because they result in decreased network performance due to an increase in the number of inter-frequency handovers in active mode or inter-frequency cell re-selections in idle mode, which, for example, increases the likelihood of call drops and decreases throughput during transition to other frequencies. There is no known technology or method for coordinating the energy savings state of each carrier at each base station in each sector of a multi-carrier network area having multi-carrier sectors. Further, there is no known technology or method for comparing and processing carriers within a multi-carrier network area having multi-carrier sectors to determine the energy-savings priority for each carrier at each base station in each sector of the network area. The functionality available by the claimed invention(s), which overcome(s) problems in the present field, is directly attributable to the present technical modifications and innovations to the OSS and SON processor, which autonomously and dynamically executes programmed operations and instructions to centrally coordinate the energy-savings state of each carrier in each sector in the multi-carrier network area.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A computer-implemented method for coordinating energy savings in a cellular network access area comprising base stations, each base station having at least one multi-carrier sector, the method comprising:
identifying first and second multi-carrier sectors having a highest handover attempt in the cellular network access area;
forming a cluster comprising the first and second sectors;
determining if the cluster is a candidate for energy savings; and
when the cluster is a candidate for energy savings, generating an energy-savings command that causes a power level reduction and a locking of at least one carrier in each sector within the cluster.

2. The computer-implemented method of claim 1, wherein determining if the cluster is a candidate for energy savings comprises determining if an action condition has been satisfied.

3. The computer-implemented method of claim 2, wherein determining if the action condition has been satisfied comprises:
determining a current capacity utilization of each sector of the cluster;
determining a maximum of the current capacity utilization across all sectors of the cluster to provide a cluster capacity utilization;
comparing the cluster capacity utilization to a pre-defined threshold value; and
determining that the action condition is satisfied when the cluster capacity utilization is lower than the pre-defined threshold value.

4. The computer-implemented method of claim 2, wherein determining if the action condition has been satisfied comprises:
determining a current user count of each sector of the cluster;
determining a maximum of the current user count across all sectors of the cluster to provide a cluster user count;
comparing the cluster user count to a pre-defined threshold value; and
determining that the action condition is satisfied when the cluster user count is lower than the pre-defined threshold value.

5. The computer-implemented method of claim 1, further comprising:
after the power level reduction and the locking of the at least one carrier in each sector within the cluster, determining whether an emergency condition for the cluster has been satisfied; and
when the emergency condition for the cluster has been satisfied,
unlocking the at least one carrier in each sector within the cluster regardless of an energy-savings priority for the at least one carrier in each sector within the cluster; and
generating a power level change command that causes a power level increase of the at least one carrier in each sector within the cluster to a first power level.

6. The computer-implemented method of claim 5, further comprising:
(a) waiting for a predetermined time period;
(b) after step (a), generating a second power level change command that causes a second power level increase of the at least one carrier in each sector within the cluster to a second power level, the second power level being a stepwise increase from the prior power level;
(c) repeating steps (a) and (b) until the second power level equals an operational power level for the at least one carrier in each sector within the cluster.

7. The computer-implemented method of claim 1, further comprising:
after the power level reduction and the locking of the at least one carrier in each sector within the cluster, determining whether a rollback condition for the cluster has been satisfied; and
when the rollback condition for the cluster has been satisfied,
unlocking the at least one carrier in each sector within the cluster; and
generating a power level change command that causes a power level increase of the at least one carrier in each sector within the cluster to a first power level.

8. The computer-implemented method of claim 7, further comprising:
(a) waiting for a predetermined time period;
(b) after step (a), generating a second power level change command that causes a second power level increase of the at least one carrier in each sector within the cluster to a second power level, the second power level being a stepwise increase from the prior power level; and
(c) repeating steps (a) and (b) until the second power level equals an operational power level for the at least one carrier in each sector within the cluster.

9. The computer-implemented method of claim 1, wherein generating the energy-savings command comprises generating a first power level change command that causes a power level decrease of the at least one carrier in each sector within the cluster to a first reduced power level.

10. The computer-implemented method of claim 9, further comprising:
(a) waiting for a predetermined time period;
(b) after step (a), generating a second power level change command that causes a second power level decrease of the at least one carrier in each sector within the cluster to a second reduced power level, the second reduced power level being a stepwise decrease from the prior reduced power level;
(c) repeating steps (a) and (b) until the second reduced power level of the at least one carrier in each sector within the cluster reaches a lower limit; and
(d) after step (c), locking the at least one carrier in each sector within the cluster.

11. A computer-implemented method for coordinating energy savings in a cellular network access area comprising base stations, each base station having at least one multi-carrier sector, the method comprising:
identifying first and second multi-carrier sectors having a highest handover attempt in the cellular network access area;
forming a cluster comprising the first and second sectors;
determining if the cluster is a candidate for energy savings; and
when the cluster is a candidate for energy savings:
determining an energy-savings priority for each frequency layer in the cluster;
identifying the frequency layer having the lowest energy-savings priority in the cluster; and
generating an energy-savings command that causes a power level reduction and a locking of the lowest energy-savings priority frequency layer in each sector within the cluster.

12. The computer-implemented method of claim 11, wherein the energy-savings priority for each frequency layer is determined based at least in part on (a) whether a corresponding sector that comprises the frequency layer operates in different frequency bands, (b) a site deployment density proximal to the base station having the corresponding sector; (c) a bandwidth of the frequency layer, or (d) a combination of any of the foregoing.

13. The computer-implemented method of claim 11, further comprising:
identifying a third multi-carrier sector having a highest handover attempt to the first or second multi-carrier sector; and
adding the third multi-carrier sector to the cluster.

14. The computer-implemented method of claim 11, further comprising maintaining a minimum number of active carriers in each sector while the cluster is in an energy-saving state.

15. The computer-implemented method of claim 11, further comprising:
after the power level reduction and the locking of the lowest energy-savings priority frequency layer in each sector within the cluster to form an energy-saving frequency layer in each sector within the cluster, determining whether an emergency condition for the cluster has been satisfied; and
when the emergency condition for the cluster has been satisfied,
unlocking each energy-saving frequency layer in each sector within the cluster regardless of their energy-savings priority; and
generating a power level change command that causes a power level increase of each energy-saving frequency layer in each sector within the cluster to a first power level.

16. The computer-implemented method of claim 15, further comprising:
(a) waiting for a predetermined time period;
(b) after step (a), generating a second power level change command that causes a second power level increase of each energy-saving frequency layer in each sector within the cluster to a second power level, the second power level being a stepwise increase from the prior power level; and
(c) repeating steps (a) and (b) until the second power level equals an operational power level for each energy-saving frequency layer in each sector within the cluster.

17. The computer-implemented method of claim 11, further comprising:
after the power level reduction and the locking of the lowest energy-savings priority frequency layer in each sector within the cluster, determining whether a rollback condition for the cluster has been satisfied; and
when the rollback condition for the cluster has been satisfied,
unlocking the highest energy-savings priority frequency layer in each sector within the cluster; and
generating a power level change command that causes a power level increase of the highest energy-savings priority frequency layer in each sector within the cluster.

18. The computer-implemented method of claim 17, further comprising:
(a) waiting for a predetermined time period;
(b) after step (a), generating a second power level change command that causes a second power level increase of the highest energy-savings priority frequency layer in each sector within the cluster, the second power level being a stepwise increase from the prior power level; and
(c) repeating steps (a) and (b) until the second power level equals an operational power level for the highest energy-savings priority frequency layer in each sector within the cluster.

19. The computer-implemented method of claim 1, wherein generating the energy-savings command comprises generating a first power level change command that causes a power level decrease of the lowest energy-savings priority frequency layer in each sector within the cluster to a first reduced power level.

20. The computer-implemented method of claim 19, further comprising:
(a) waiting for a predetermined time period;
(b) after step (a), generating a second power level change command that causes a second power level decrease of the lowest energy-savings priority frequency layer in each sector within the cluster to a second reduced power level, the second reduced power level being a stepwise decrease from the prior reduced power level;
(c) repeating steps (a) and (b) until the second power level of the lowest energy-savings priority frequency layer in each sector within the cluster to a second power level reaches a lower limit; and
(d) after step (c), locking the lowest energy-savings priority frequency layer in each sector within the cluster.
